(19) United States
(12) Patent Application Publication
(10) Pub. No.: US 2015/0261866 A1
(43) Pub. Date: Sep. 17, 2015

(54) DEVICE, SYSTEM AND METHOD FOR FACILITATING COMMUNICATIONS

(71) Applicant: Grace Maria Cerrone, West Hollywood, CA (US)

(72) Inventor: Grace Maria Cerrone, West Hollywood, CA (US)

(21) Appl. No.: 14/207,038

(22) Filed: Mar. 12, 2014

(51) Int. Cl. G06F 17/30; G06Q 50/00

(52) U.S. Cl. CPC G06F 17/30867; G06Q 50/01

(57) ABSTRACT

Devices, systems and methods facilitate communications, such as those for political organization, processes, and presence. For example, the devices, systems and methods allow individuals to participate or observe the formation of processes and groups to meet goals. When used in a political process, users or group organizers can search for topics that lead to specific information about legislation, movements, coalition, groups, and other concerns. Using this information the user can join the groups or form new groups and establish communications for the groups.

### CROSS-REFERENCE TO RELATED APPLICATIONS

This application claims priority under 35 U.S.C. 119 to Provisional Application No. 61/778,392, hereby incorporated by reference in its entirety.

### FIELD OF INVENTION

The invention is related to a device, system and method for facilitating communications. Example embodiments contemplate facilitating a political process where the parties including the citizenry and/or governmental officials may form groups and provide related communications with such groups to meet desired goals.

### BACKGROUND OF THE INVENTION

Political systems have taken many forms over time leading to the rise of democracies and other forms of government. These governments and movements can form in any region of the world changing political systems in a region over a period of time. The people of a given region come together to form groups that can lead to political consensus to bring about change for a given cause or issue. In a paper entitled “Networking vs. Allying: The Decision of Interest Groups to Join coalition in the US and the EU”, by Dr. Christine Mahoney, she sites tradition methods for building consensus for a political movement. Traditional methods utilize advocacy coalitions, lobbyist, and interest groups that ally together to pursue a common agenda and lobby to governmental entities and others to for political or societal change. FIG. 1 shows the traditional process for building a political process 100 to lobby against an issue. An event or cause 101 can cause an individual or entity to desire to build a political movement or process and establish goals. Often during this initial step there becomes a need to collect resources 102. Obtaining resources in the traditional methodology necessitates the crossing of a boundary 108 (that can be physical or temporal) leads to expense. E.g., an inordinate amount of time may pass in an effort to collect resources and indeed time is a resource that can never be recovered or there may be difficulty in fund raising. To raise public awareness and sympathy 103 for the cause one must cross a boundary 109 and as before this leads to expense. Advertising costs, reaching out to the public, calling the public, spending time to write letters and email potential supporters requires office staff, office buildings, and time. The remaining steps of cataloging supporters and building a network 104, lobbying decision makers 05, and evaluating results 106 requires crossing expensive boundaries (110 111 112) and if the desired outcome is not obtained the process loops back and repeats. Rarely, this process meets its desired outcome on its first attempt. Crossing boundaries does not often lead to completing the organizations goals 107 without, in many cases, great expenditures of resources. Thus, lobbying and building coalitions for the most part has become an avenue for the most influential to project their thoughts and wishes upon the citizenry via the governmental officials. The most effective lobbying methodologies have placed barriers to the masses for creating the influence and advocacy for political or social action. These traditional methodologies have led to political systems where informal activities that lead to building coalitions and advocacy for major societal change are rare.

### SUMMARY

Devices, systems and methods are disclosed to facilitate communications. When used in a political process, citizens may create influence through communications, whether they are individuals, groups, large institutions, active lobbyists or other entities.

Embodiments disclosed herein facilitate communications, such as communications within a political process, to reduce costs and reduce barriers associated with of traditional communication schemes.

Some embodiments are directed to a device, system and method for political processes that is easily accessed and utilized, unique, ubiquitous, personalized, engaging and available to all.

Some embodiments provide a device, system and method for political processes that is secure and may provide a secure separation of information when necessary for process anonymity.

Some embodiments provide the capacity for everyone to build a political process or group, such as, a coalition, movement, or advocacy group.

Some embodiments provide communications within political processes that can lead to political and social change at a faster pace than traditional processes.

Some embodiments allow individuals or organizations with minimal resources to form coalitions, build interest groups, and, through this process and combined efforts, petition the government or other organizations with similar capability as traditional organizations with a reduced resource footprint.

Some embodiments allow an individual or organization with an initial small network and very few contacts to build an expansive coalition to provide advocacy for an issue or cause.

### BRIEF DESCRIPTION OF THE DRAWINGS

FIG. 1 depicts a tradition process for building advocacy coalitions which normally requires many resources and an existing network with access to lobbyist and interest group leaders.

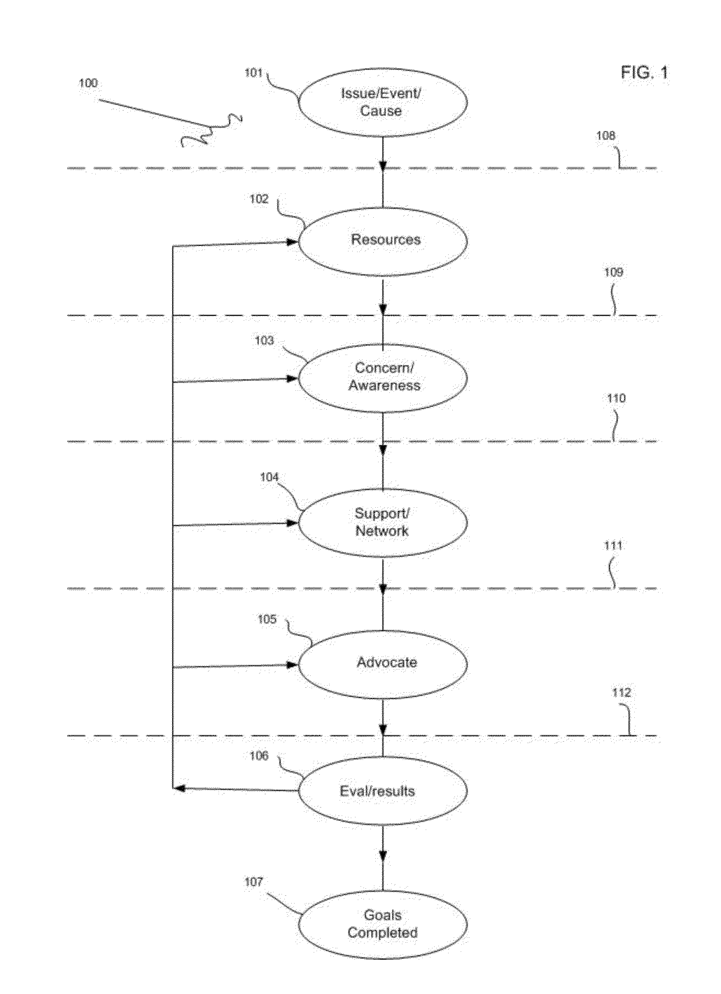

FIG. 2 depicts an exemplary system, associated devices, and method for facilitating communications, such as those for political organization.

FIG. 3 depicts a user processing component of the system and method of FIG. 2.

FIG. 4 depicts an exemplary method.

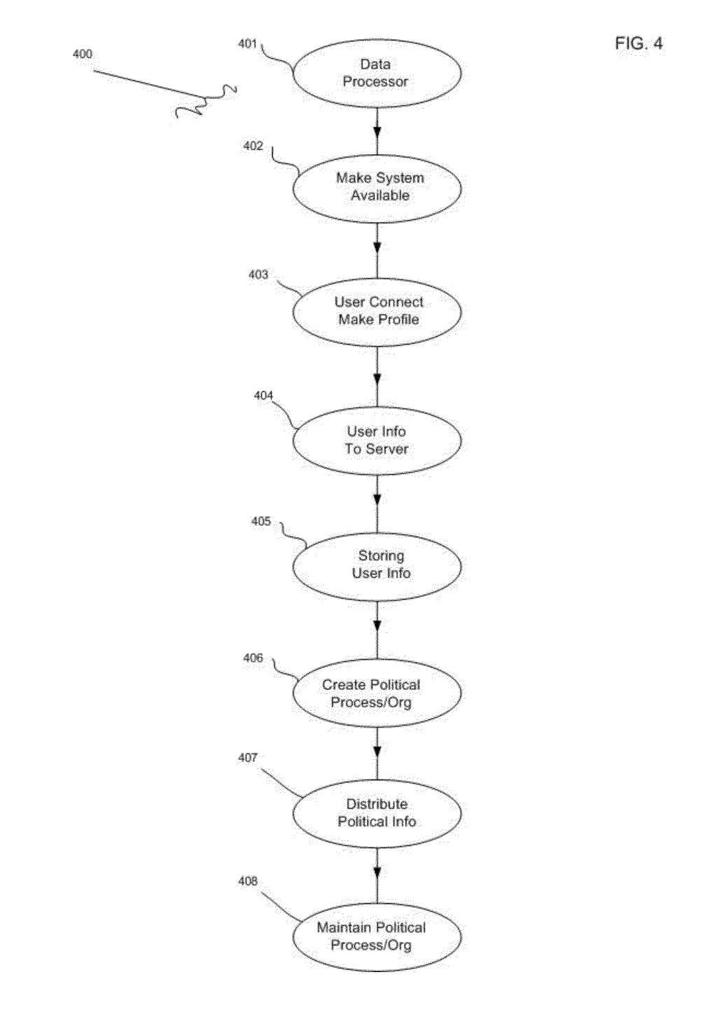

FIG. 5 depicts an exemplary method to personalize system action in the user processing component of the system.

FIG. 6 depicts an exemplary method for sending messages in the system.

FIG. 7 depicts an exemplary method for coalition building in the system.

FIG. 8 depicts an exemplary method for training coalition organizers to use the system.

FIG. 9 depicts an exemplary method of the system.

FIG. 10 depicts an exemplary method for showing and sharing support for a group or movement.

FIG. 11 depicts an exemplary method for recommending bills and groups in the system.

FIG. 12 depicts an exemplary method for multi-user bill summary and discussion an exemplary.

FIG. 13 depicts an exemplary method for multi-user bill creation in the system.

FIG. 14 depicts an exemplary method for holding officials accountable in the system.

FIG. 15 depicts an exemplary method for using the think tank to provide feedback.

FIG. 16 depicts an exemplary method for blogging.

### DETAILED DESCRIPTION

Embodiments described herein may operate in a computing environment composed of many devices connected to a network of devices composed of gateways, switching gear and storage. The devices may comprise and are not limited to hand held computers, phones, and devices that connect to the internet. The devices may include processing elements, display elements, input/output devices and network connections. These networks may comprise internets, intranets, and the Internet. The aforementioned devices may create a system and implement methods for facilitating communications, such as facilitating communications for political organization, processes, and presence.

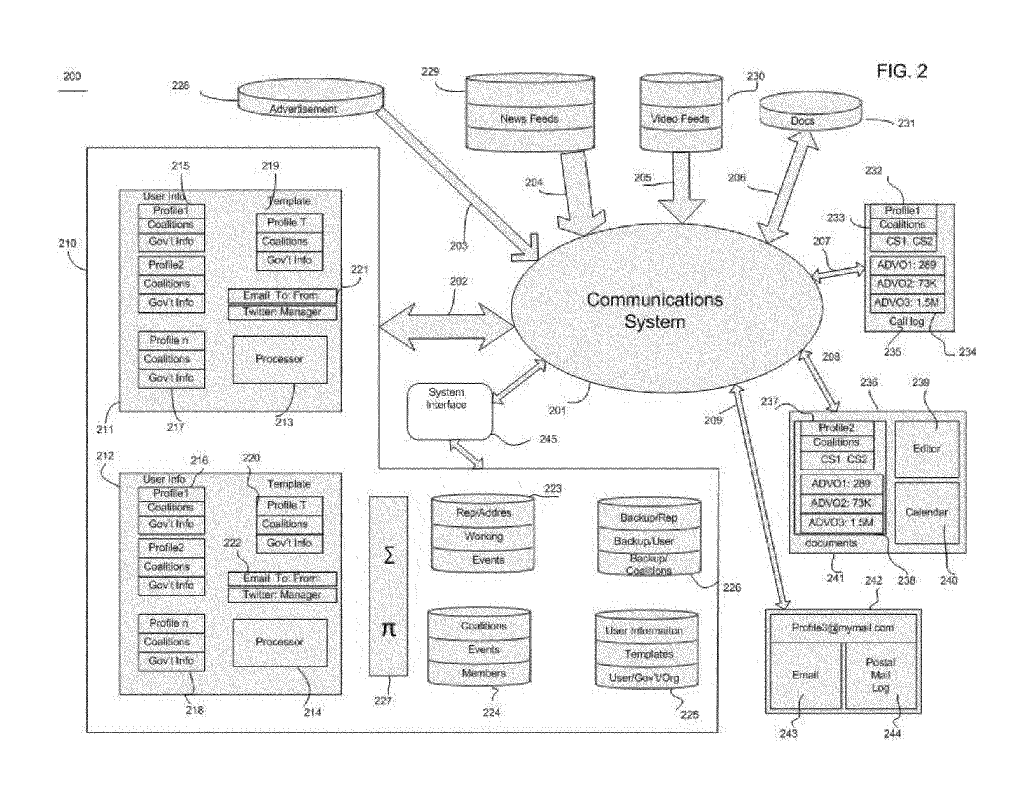

FIG. 2 illustrates an exemplary embodiment of the invention. The system 200 shown in FIG. 2 is comprised of many components to process, store, control the flow of information. In this example, system 200 is implemented to facilitate communications within a political process, however, the invention is not limited thereto. In the political process networking is central to building relationships with others. In one embodiment, communications system 201 may comprise an internet, intranet, or the Internet for transporting messages and/or information when directed by the systems controls. The networks may utilize available protocols to send and receive information via connections 202 whether they are wireless, or wired network connections, from other components in the system. While this embodiment uses a distinct network, the system can be implemented on a general purpose computer where the communications system 201 can be the system bus of the computer. Connections 202 203 204 205 206 207 208 209 can be unidirectional or bidirectional and interface the networking elements within the communications system 201 and the networking elements within other components in the system. The communications system 201 is networked to the main processing component 210 of the system. The main processing component 210 also has a system interface 245 that may be local and accessed through the communications system 201 for maintenance of the system by administrators. The system interface 245 may also provide an interface for new users of the system. The public portion of the system interface 245 is informative and is used to report information stored by system 200, such as aggregate information, which may include the number of coalitions, interest areas, responses to legislation, number of users, and most popular advocacy messages.

As shown in this embodiment, the main processing component 210 has two control elements 211 212 with processors 213 and 214 and memory for storing user information 215 and 216, profile information 217 and 218, template information 219 and 220, and messaging components, such as email and twitter 221 and 222. The user information and profile information are used to set up security and permissions of a user account. In operation, the main processing component 210 can be implemented as a web server or any servelet container. The user profile information may contain links to coalitions that are managed and maintained by the user and links to other coalitions of interest. The main processing unit can access a plurality of storage media for representative information 223, coalition information 224, user information 225 and storage backup 226. An additional memory area 227 is provided for storing summation and statistical information about the information maintained in the other storage area with regard to coalition membership, users, and correlated information pertaining to the data stored. The main processing component 210 has additional sources of information that can be accessed through the communications system 201. These remote information sources include advertisement information 228, news feeds 229, video feeds 230, and other sources 231, such as documents. Exemplary components for the main processing component 210 include Microsoft web servers or Apache Tomcat web servers. The storage is presented as storage drums which may be typical storage media as RAID units, tape drives, internal and external hard drives storing information in flat files or computer databases. The remote data sources may provide streams of information in text, multi-media format and other formats. The main processing component 210 may interact with remote systems to provide information and facilitate the transmission and reception of information with these systems.

The aforementioned remote systems provide processing and communications for users of the system. User processing component 232 is a lightweight version for devices having limited storage and processing capability such as a cellular phone or small hand held tablet computer. In this embodiment, the user processing component may provide a user access to a subset of the features otherwise available with system 200. In this example, the limited version 232 allows a user can review coalition information 233, advocacy information 234, and a call log 235. In this embodiment, a user can have phone calls directly logged into the system. Another more capable user processing component 336 provides additional functionality. This processing component 336 may implemented on devices that have more processing and memory capabilities and may be implemented on a general purpose computer with the capability to access remote systems through the communications system 201 via a browser or client/server software. In this example, processing component 336 includes coalition information 237 and advocacy information 238 similar to that in the lightweight user processing component 232, an editor 239, calendar 240 and documents 241. Other features that are not shown may include components for displaying data, multi-media, and messages from the devices connected to the communications system 201 including the main processing system 210. This processing system is capable of being configured to display presentations representative of information and data sources. Another user processing component 242 is shown for a limited user where email 243 and a postal mail log 244 are shown. The underlying processing device may range in capability from a limited system or high capability processing system. Limited capability processing systems may be for users with limited access or other users only needing limited capability for a particular interaction with the political organization system 200.

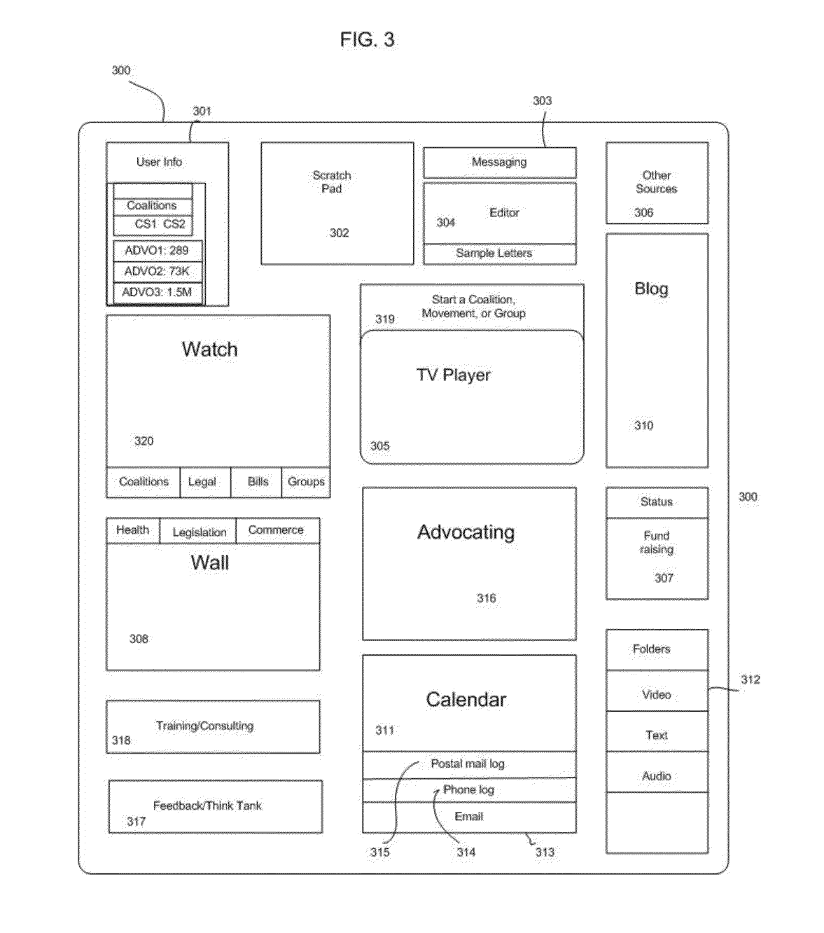

FIG. 3 illustrates exemplary details of a user processing component such as those described in this disclosure. As described above this user processing component can be customized, may comprise lightweight components for both devices such as cellular phones and lightweight versions for users desiring limit use. The user processing component 300 in FIG. 3 is shown with components to implement a system and methods for political organization, such as, building interest groups and communication to the government or other officials. The user processing component 300 allows the user to create political organizations and processes with minimal boundary crosses and context changes. It provides a system where many political activities, such as, fund raising, membership drives, advertising, contacting constituents, and building coalitions can be accomplished in the same context. The system components and sub-component may operate on a general purpose computer or may operate on a computing device that is capable of processing computer coded instructions that controls and directs the operation of the central processing unit, input/output components, internal memory, secondary memory, display and other computer elements. These system components once read into the internal memory of the computing device and subsequently processed cause changes in the electromagnetic state of each component in the device to maintain and update the state of each component as directed. In one particular case, code computer instructions when activated cause the flow of electromagnetic signals through computer wiring to the secondary memory to change the atomic state of the memory to persist the storage of information. Other computer coded instructions when activated in the internal memory of the processing device cause changes in the computers display memory area to change what is presented on the computer's screen. In discussing the sub-components of the user processing system 300 some of the lower level details will be abstracted since they follow from the previous examples which discuss the operation of a general purpose processing device.

In this example, a user must obtain a password or other type of token for access to a computing system and once access is obtained the features of the system may be utilized. The first sub-component of the user processing component 300 to discuss is the user information section or profile 301. This sub-component 301 defines the scope of operations of a user, and allows for configuration of the user processing system 300. This sub-component 301 may provide an initial default operation and may allow customization of each sub-component in the system. This customization may provide privacy settings and allow configuring of activities, visualizations, and system components. A user can perform functions that include hiding, sharing, blocking, and broadcasting information entering, leaving, and displayed in the system. The user information section 301 may provide notification options for other sub-components in the system that will be discussed as follows. A scratch pad area 302 is used for making notes, organizing thoughts, and planning of political processes. Available for use in the scratch pad 302 area are templates for building a political process that provide instructions for using the system to create a political process that may include the use of messaging sub-components 303, television sub-components 305, and email to provide an advertising campaign for a political process. Above the television sub-component 305 is a banner/link to add a coalition which may start a process to create a new coalition, input information about the coalition, store the coalition information in the system database, and use the information to publish a web page for the coalition that can be maintained by the user. Other sub-components having known functionality include instant or short text messaging 303, an editor 304, a video player as a television 305, a calendar 311, email 313, and blog 310. Other sources 306 of information are available to the system include web camera inputs, downloads from other sites, http links, subscription services and news channels. A status 307 area is include for maintaining the status of political activities and others of interest such as fundraising, and responses to activities. There is a sub-component for receiving messages from parties not designated in the watch 320 sub-component. This sub-component is known as the wall 308 where messages are received from sources designated by the user in addition to those in the watch 320 area and the user can post messages here in response to those messages. The watch 320 is depicted with coalition, legal, bills, and groups where each of these parameters are only indicative of lists of specific organizations, processes, entities or documents being observed. This area can receive messages from any source whether they are short text or long text messages and are received via the messaging service 303. Message filtering is also available with the configuration of this available in the user information 301 sub-component and statistical information is available to ascertain what messages and subjects are creating the most interest. In some configurations the wall 308 may be combined with the watch sub-component 320. A folders 312 sub-component is available to display file names and folders available in the system that are stored in secondary storage. This system is capable of storing files of many formats from text to full multi-media formats and displaying files available locally and remotely via the communications system. Information can be downloaded from the other sources 306 to the folder storage area or uploaded from the system using the folders directory structure. The user processing system 300 includes logs such as postal mail logs 315, phone logs 314 and email logs 313 with usual features such as sorting and search. The sub-components of the user processing system 300 provide configuration, organization of thoughts, messaging, editing, presentation of information, storage of information, logs, events, and other sources.

Other sub-components of the user processing system 300 may provide a user services inherent in the system, such as storage in the main processing component 210 or requested consulting. The watch 320 sub-component of the user processing system may allow a user to review and select from predefined information such as laws, legislation, events, activities, officials, corporations, and other services that may be provided by the system. This information is classified into divisions with respect to interest areas. In the government section, a user is provided information with regard to the individuals and their official positions whether elected are not. For example a user may be able to determine all of the mayors of cities within a particular country or get information about the representatives in a particular geographic area. This section also allows for the sorting of officials with regard to membership parties. Once an official is determined, a user may review his positions on many issues including legislation, laws, voting positions, and other activities. A user can also search for legislation based upon an interest area to determine who supports it and all of the proposals before a governing body for that interest area. A user may use the information obtained to send messages of support or concern to government officials, using the editor 304, email 313, or messaging services 303. A user may also search for events and activities concerning a particular group to ascertain what legislation may be supported by the group. In addition to searching, the watch 320 sub-component in this example provides the predefined categories with regard to legislation, laws, people, interest groups, and activities. The user may select a category and review pertinent information in that category related to the activities or services desired. Once the user has selected a category, topic, interest area, legislation, individual, entity, corporations, or group, the watch 320 area may provide predefined information and be configured to receive information from other areas of the user processing system 300, such as from television 305, messaging service 303, news feeds, or blogs 310. The watch area is also updated with the latest available messages regarding a search category chosen when the user has requested to be notified in the user information 301 section. The user can also send out or broadcast messages about opinions regarding the chosen category from the search area in an effort to obtain opinions that can be presented on the wall 308 sub-component and summarized for presentation. In the example of FIG. 3, the wall 308 shows health, legislation, and commerce as interest areas for a user, where a multitude of interest areas can be designated. In an alternative implementation, the watch 320 and wall 308 may be combined into one component, which may be efficient since they work in conjunction to present information content from established sources along to with information from other users of the system and users who may message information to the user processing 300 subcomponent via short text, e-mail, and direct post to a user wall 408 if permitted. The coalitions 319 sub-component provides for an area for examining coalitions and for adding new coalitions to a user's information. The coalitions 319 sub-component may be incorporated in the watch 320 in some implementations. However, it is shown as a separate sub-component in FIG. 3. In the coalitions 319 sub-component, a user can, e.g., research coalitions within the system, request addition to coalitions, start new coalitions, start a new group, start a new movement, invite others to join a coalition, and broadcast coalition messages. The user is able to monitor coalitions that are maintained in the user's profile, is notified of new coalitions forming in selected interest areas, and is kept appraised of events, legislation or activities from the watch 320 that are related to a coalition. The user may have access to predefined information that can be further enhanced, commented on, added to, and projected to other users and non-user via the messaging services, emails, or traditional methods while assuring logs are maintained regarding these activities.

The user can use the editor 304 and messaging 303 sub-components to send out messages individually or broadcast them. This capability is enhanced by the advocacy 316 sub-component which provides the user an area to work in conjunction with the watch 320 and coalitions 319 sub-components to show advocacy and support to groups, coalitions, entities, individuals, messages, causes, or interest whether predefined in the system or outside the system. The user can then provide links to the wall 308 by the title of an advocacy message, maintain a separate display area of advocacy messages, or store the advocacy message in the folder 312 for public or private retrieval. The advocacy 316 sub-component works with the editor 304 sub-component to facilitate the creation of new messages. Showing support for political processes and organizations may also be implemented. Receiving support related to the show of support, and the ability to organize new causes, groups, coalitions, send messages to all parties concerned, and utilize a trusted political process and organization framework may also be implemented. A feedback/thinktank sub-component is also provided for sending support message to the system's operational staff about the presence provided and this message of support can be posted to the user's wall 308 and broadcast through the messaging sub-components.

A training and consulting 318 sub component is provided to help users get the most out of the system. The previously mentioned scratch pad 302 sub-component provides templates for using the system to build political organizations and processes. The user may also have access to training and consulting internal to the system and provided by the system's operation staff. Internal training inherent in the system is provided by training documentation and multi-media presentations that may be made available at any time. Further consulting can be scheduled with the system's operational staff to build complex new political organization, group, and processes by enhancing templates to direct the user using a script that demonstrates how to use the full extent of the user processing system 300 sub-components in to make a plan of action to create and enhance a process, activity, or formation of a group.

The devices, systems and methods for facilitating communications, such as for political organization, processes, and presence can be utilized for execution of novel methods to accomplish the goals of the user. Discussions of exemplary methods that may be implemented by the systems and devices described herein follow:

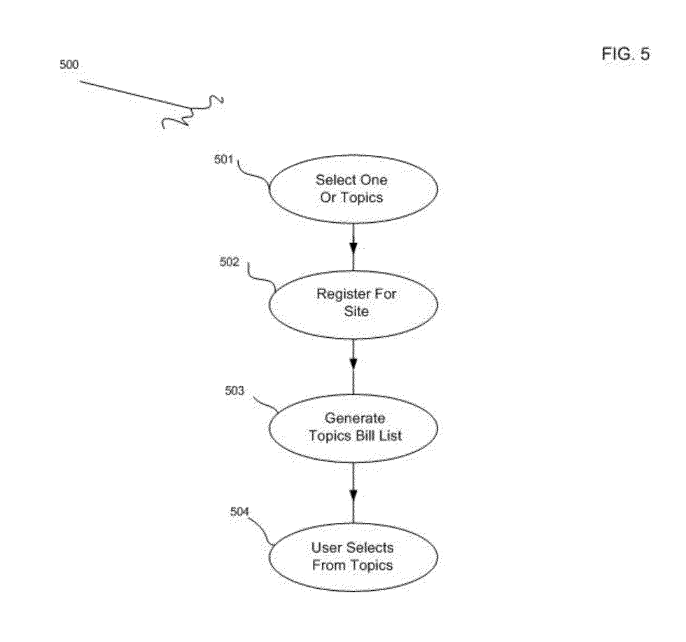

### FIG. 5. Personalize System Action 500

| Title | Description |
|---|---|
| Select one or all | User selects topics of interest from a system |
| topics of interest | generated list. |
| 501 | |
| Register for site 502 | Registration comprieses user input of legal name, |
| | home address, age, gender and email address |
| System generates | A list of topic-related bills are published on all user |
| topics bill list 503 | pages based |
| User selects from | User takes action by selecting from among bills |
| topics bill list 504 | published on personalized topics-bill list |

The Personalize system action method described is for bills in the system. Instead of bills, the user can also choose movement, coalitions, or interest groups to join.

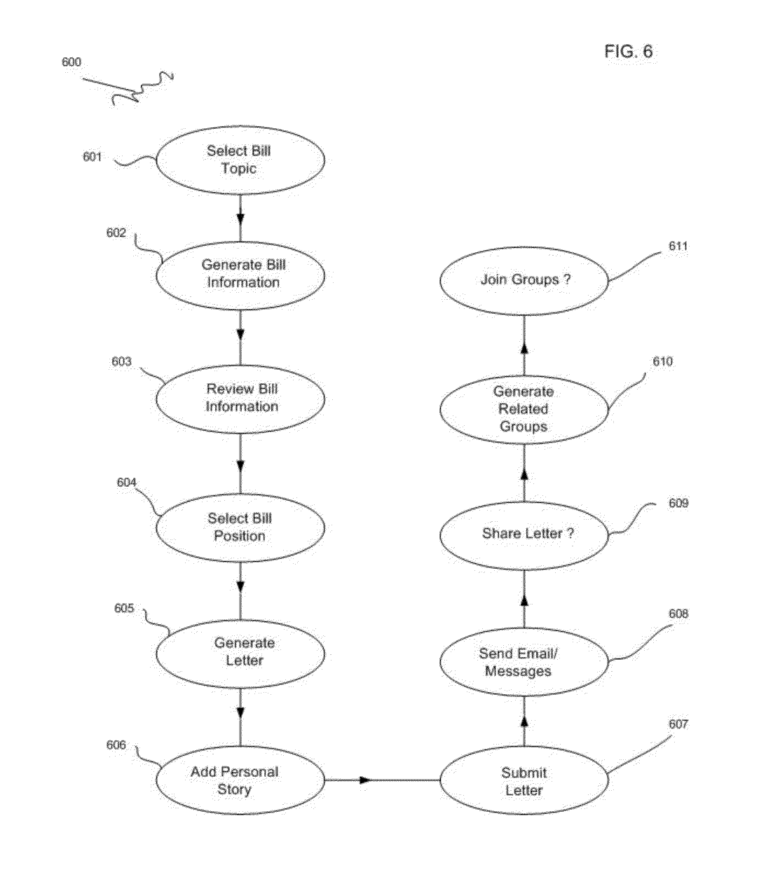

FIG. 6. Send a Message to Someone 600

| Title | Description |
|---|---|
| User selects from | User takes action by selecting from among bills |
| topics bill list 601 | published on personalized topics-bill list. |
| System generates | System generates information on bill including, |
| multi-media bill | but not limited to, the following formats: video, |
| information 602 | podcast, audio, text, graphics, images. |
| User reviews bill | User utilizes one or more media formats to |
| information 603 | review and understand bill. |
| User selects | User selects a position in support or opposition |
| a position 604 | of the bill. |
| System generates | Based on user personal information provided in |
| letter 605 | FIG. 5, Step 2, and the user's position in |
| | FIG. 6, Step 4, the system generates a draft |
| | letter to user's decision officials. |
| User adds | User customizes draft letter to include personal |
| personal story 606 | story. |
| User submits | User selects submit button to send the user's |
| letter 607 | position email to their deciding officials. |
| System sends | System processes email to user's deciding |
| email 608 | officials. |
| User shares (or does | Users selects to share or not share position |
| not share) letter | email with social media websites including, but |
| 609 | not limited to, Facebook, Twitter, LinkedIn, |
| | MySpace, Pinterest. |
| System generates | Based on user's selection in FIG. 6, Step 4, |
| position-related | system generates a listing of groups with similar |
| groups 610 | position. |
| User selects to | User can select to participate in group(s) that |
| join similar group 611 | further bill or topic related action. |

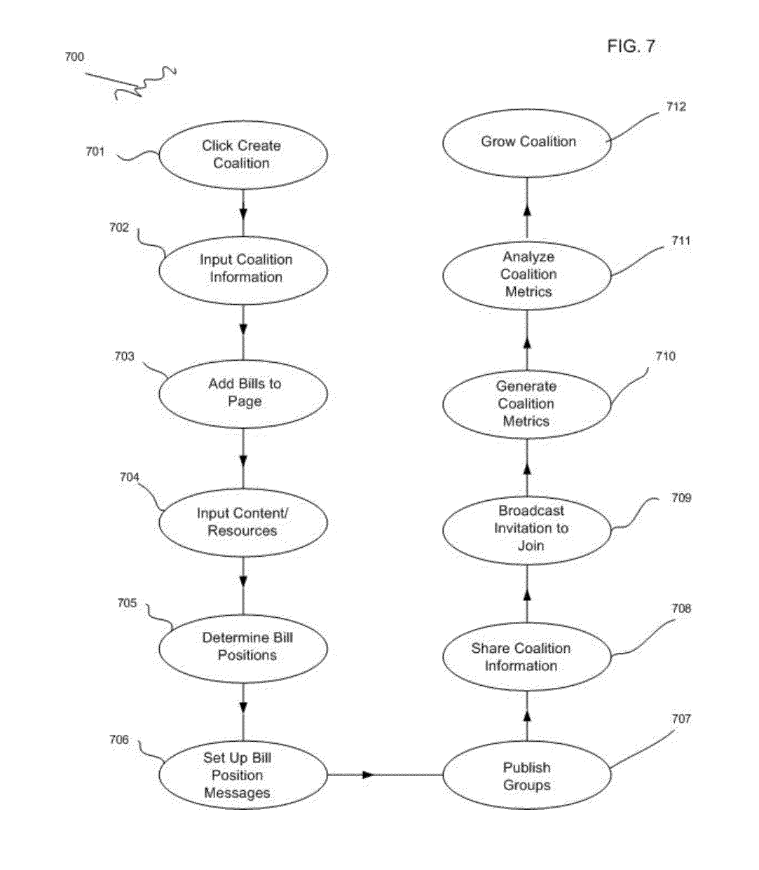

FIG. 7. Build a Coalition 700

| Title | Description |
|---|---|
| User clicks on | The system assigns this user as the organizer and |
| “create a coali- | requests a co-organizer to help lead. |
| tion” button 701 | |
| Organizer inputs | The organizer selects keywords and with the named |
| coalition title 702 | title, the system stores this information for the |
| | recommend feature and the list features in the |
| | database. |
| Select bill to | The organizer either chooses from the bill library one |
| add to page 703 | or more bills to list on the coalition main page. By |
| | default, the system will list the bill and position from |
| | the organizer if the condition is that the organizer |
| | selects to “create a coalition” button from the final |
| | page of the letter writing process. |
| Organizer uploads | Organizer uploads content and assets to the coalition |
| content and assets | including, but not limited to: bylaws, mission, video |
| 704 | and audio assets, images, graphics, events, files and |
| | folders, linked resources and online meetings. |
| Determine the | Organizer selects a default bill position for the |
| message position | coalition for all bills selected for the main page for all |
| 705 | members who click through to speak to their deciding |
| | officials. |
| Set up default | If the condition is the organizer selects a bill to attach |
| position message | from the library database, the organizer creates has a |
| 706 | personalized position message of the coalition to the |
| | deciding officials from its members. |
| Publish group 707 | Organizer concludes group creation by clicking button |
| | to publish. Published groups are added to system |
| | database. |
| Share coalition | System generates share tools for organizers to |
| information | advertise coalition in social media including, but not |
| (advertise) | limited to, Facebook, Twitter, LinkedIn, MySpace, |
| 708 | Pinterest. |
| Broadcast | System generates broadcast tool for membership |
| membership | invites |
| invitation | |
| email 709 | |
| Coalition data | System generates all coalition analytics. |
| metrics 710 | System delivers report of coalition analytics to |
| Analysis | organizer. |
| reports 711 | |
| Organizer | Organizer tool set includes all methods to grow |
| tools 712 | coalition. |

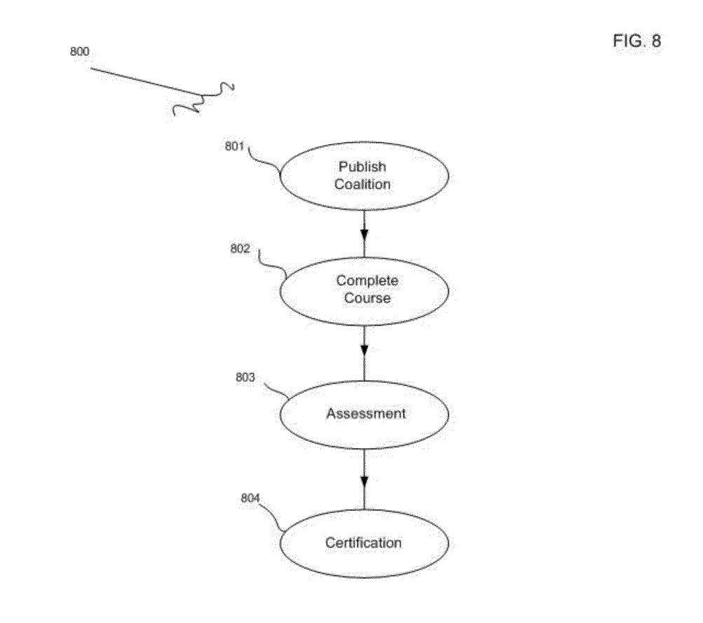

FIG. 8. Training Coalition Organizers 800

| Title | Description |
|---|---|
| Organizer publishes | System generates participant default when |
| coalition 801 | organizer publishes their coalition. |
| | Publishing of page to web. |
| Organizer takes multi- | System generates participation in multi- |
| media training courses | media training of organizers as training |
| 802 | occurs. |
| Organizer takes online | System generates organizer assessments |
| training assessments | after organizer completes the multi- |
| 803 | media online training course tracks. |
| System certifies organizer's | System generates certification after |
| successful completion of | organizers successfully pass the assessment. |
| training 804 | |

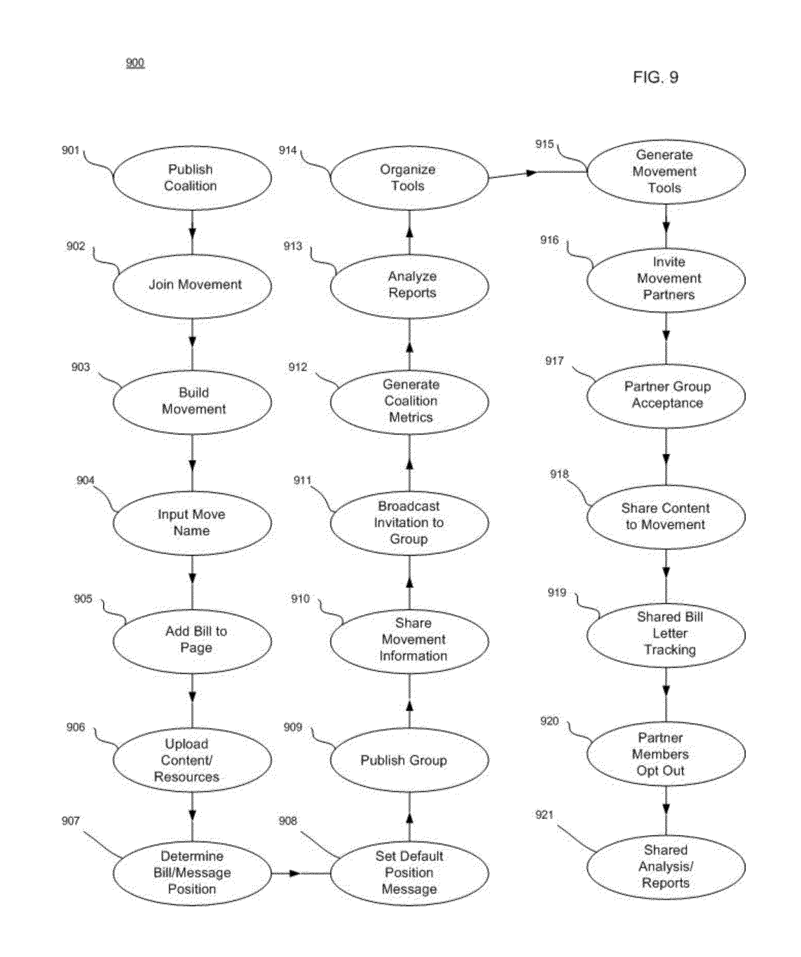

FIG. 9. Build a Movement 900

| Title | Description |
|---|---|
| Organizer publishes | After coalition is created, system generates |
| coalition 901 | list of groups and movements with related |
| | bills and positions and provides a “build a |
| | movement” and/or “join a movement” |
| | button for organizer to establish movement |
| | relationships. |
| Organizer clicks | The system sends join movement request |
| “join a movement” 902 | to movement. |
| Organizer clicks | The system assigns this user as the |
| “build a movement” 903 | organizer and requests a co-organizer to |
| | help lead. |
| Organizer inputs | The organizer selects keywords and with |
| movement title 904 | the named title, the system stores this |
| | information for the recommend feature |
| | and the list features in the database. |
| Select bill to | The organizer chooses from the bill library |
| add to page 905 | one or more bills to list on the movement |
| | main page. By default, the system will list |
| | the bill and position from the organizer if |
| | the condition is that the organizer selects to |
| | “create a movement” button from the final |
| | page of the letter writing process. |
| Organizer uploads | Organizer uploads content and assets to |
| content and assets 906 | the movement including, but not limited to: |
| | bylaws, mission, video and audio assets, |
| | images, graphics, events, files and folders, |
| | linked resources and online meetings. |
| Determine the | Organizer selects a default bill position for |
| message position 907 | the movement for all bills selected for the |
| | main page for all members who click |
| | through to speak to their deciding officials. |
| Set up default | If the condition is the organizer selects a bill |
| position message 908 | to attach from the library database, the |
| | organizer has to create the personalized |
| | position message of the coalition to the |
| | deciding officials from its members. |
| Publish group 909 | Organizer concludes group creation by |
| | clicking button to publish. Published |
| | groups are added to system database. |
| Share movement | System generates share tools for organizers |
| information | to advertise coalition in social media |
| (advertise) 910 | including, but not limited to, Facebook, |
| | Twitter, LinkedIn, MySpace, Pinterest. |
| Broadcast membership | System generates broadcast tool for |
| invitation email 911 | membership invites |
| Coalition data | System generates all movement analytics. |
| metrics 912 | |
| Analysis | System delivers report of movement |
| reports 913 | analytics to organizer. |
| Organizer | Organizer tool set includes all methods to |
| tools 914 | grow movement. |
| System generates | System generates lists of like-movements |
| organizer movement | that the organizer can select to invite and |
| tools 915 | grow movement participation. System |
| | offers social media tools for partner groups. |
| Organizer invites | Organizer selects from system generated |
| movement partners | movement process of similar movement list |
| to join 916 | to invite and grow the movement. |
| Partner groups | Once the invited partner group accepts |
| acceptance 917 | participation in the movement, the system |
| | defaults all members from partner groups |
| | to be listed as members of the movement |
| | on their individual user profile wall. This |
| | may be based on their selected user privacy |
| | preferences that override the default |
| | privacy preferences of the system. |
| Shared content of | System shares content from all partner |
| the movement 918 | groups and movements among the |
| | movement partners. |
| Shared bill | A system makes bill letters available from |
| letter tracking 919 | one movement partner to all movement |
| | partner members for sending to decision |
| | officials. |
| Partner group | System provides an opportunity for |
| members opt out 920 | movement member coalitions and |
| | individuals to opt-out of participation in the |
| | movement and movement partners. |
| Shared analysis | System provides analytics and reports to all |
| and reports 921 | movement group members about the |
| | activity of all movement group members. |

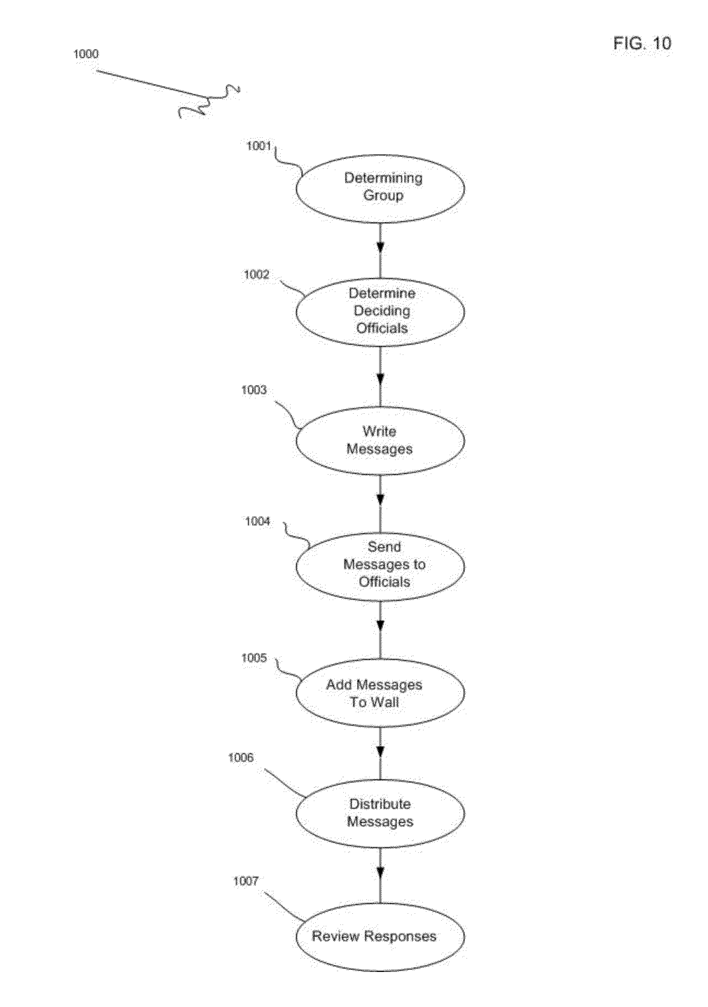

FIG. 10. Sharing Support for a Group, Movement, etc. 1000

| Title | Description |
|---|---|
| Determining group 1001 | User chooses groups based on system |
| | recommendations and user search. |
| Determining deciding | System aggregates data to determine |
| officials 1002 | deciding officials for each user. |
| Write messages 1003 | System provides pre-written position letters |
| | in support or opposition of the bill selected |
| | by the user. User may or may not customize |
| | the pre-written position letter and add their |
| | personal story. |
| Send messages to deciding | System processes email to user's deciding |
| officials 1004 | officials. |
| Add messages to wall | Share deciding officials letter with, but not |
| 1005 | limited to, coalition and fellow members. |
| Distribute messages to | Users selects to share or not share position |
| other social channels | email with social media websites including, |
| 1006 | but not limited to, Facebook, Twitter, |
| | LinkedIn, MySpace, Pinterest. |
| Review responses 1007 | System provides tools for posting comments |
| | to user's deciding official's letter. |

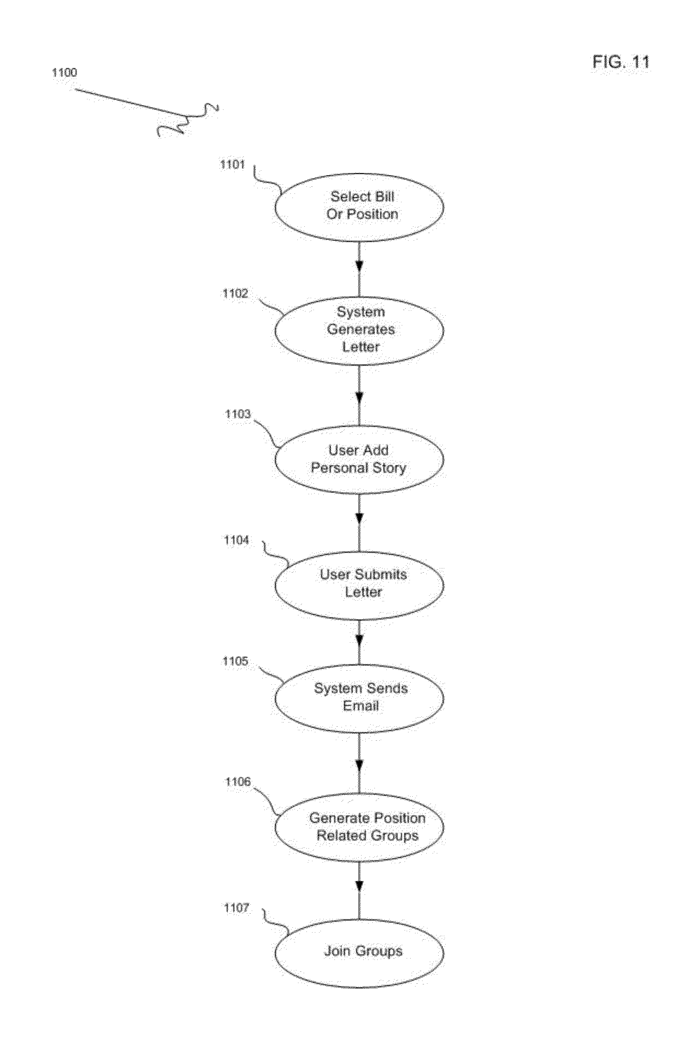

FIG. 11. Process to Recommend Bills and Groups 1100

| Title | Description |
|---|---|
| User selects a bill | User selects a position in support or |
| position 1101 | opposition of the bill as in FIG. 6, Step |
| | 4. |
| System generates letter 1102 | Based on user personal information |
| | provided in FIG. 5, Step 2, and the |
| | user's position in FIG. 6, Step 4, the |
| | system generates a draft letter to user's |
| | decision officials. |
| User adds personal story | User customizes draft letter to include |
| 1103 | personal story. |
| User submits letter 1104 | User selects submit button to send the |
| | user's position email to their deciding |
| | officials. |
| System sends email 1105 | System processes email to user's |
| | deciding officials. |
| System generates position- | Based on user's selection in FIG. 6, |
| related groups 1106 | Step 4, system generates a listing of |
| | groups with similar position. |
| User selects to join | User can select to participate in group(s) |
| similar group 1107 | that further bill or topic related action as |
| | in FIG. 6, Step 11. |

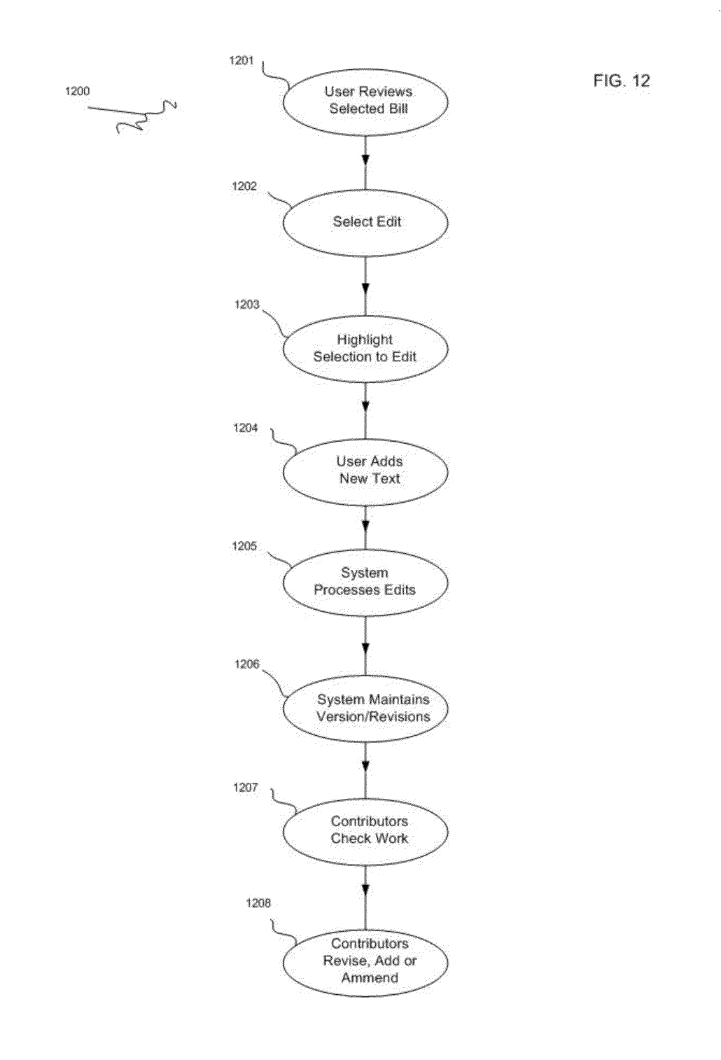

FIG. 12. Multi-User (Wiki) Bill Summary Drafting 1200

| Title | Description |
|---|---|
| User reviews | User selects bill to review from either |
| selected bill 1201 | the library or bills listed in their topics. |
| User selects the | User chooses become a contributor and |
| edit button 1202 | edit the bill summary in accordance with |
| | system editing guidelines which include |
| | but are not limited to neutrality, |
| | balance, and accuracy. Partisan |
| | perspectives are not allowed in the bill |
| | summary wiki. |
| User highlights | System saves this edit and registers the |
| section to edit 1203 | user's information for version control. |
| User adds new text 1204 | System saves this change and registers |
| | the user's information for version |
| | control. |
| System processes edit 1205 | System processes the edit for approval |
| | before publishing. |
| System has version | Each edit is subject to other contributors |
| and revision control 1206 | who can utilize version control and |
| | revise utilizing this system process. |
| Contributors check | Contributors review edits made by other |
| work 1207 | contributors to enforce system editing |
| | guidelines which include but are not |
| | limited to neutrality, balance and |
| | accuracy. System process shows specific |
| | prior contributing edits. |
| Contributors revise, | System processes version and revision |
| add or otherwise amend | control based on the current |
| 1208 | contributor's behavior. |

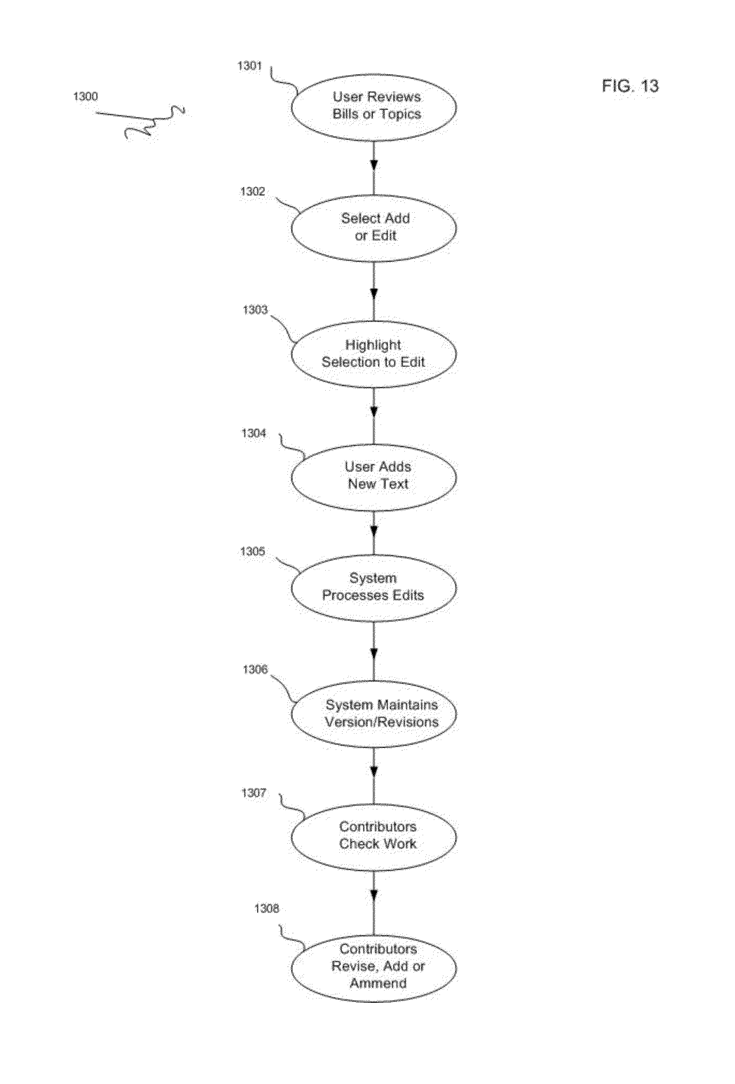

FIG. 13. Multi-User (Wiki) Bill Drafting 1300

| Title | Description |
|---|---|
| User reviews | User selects topic or bill from either the |
| bills or topics 1301 | library or bills listed in their topics. |
| User selects the | User chooses become a contributor and |
| edit or add button 1302 | either edit the bill or create their own in |
| | accordance with system editing guidelines |
| | which include but are not limited to |
| | neutrality, balance, and accuracy for decency |
| | and a stronger argument. Partisan |
| | perspectives are not allowed in the bill |
| | summary wiki. |
| User highlights | System saves this edit and registers the user's |
| section to edit 1303 | information for version control. |
| User adds new text 1304 | System saves this change and registers the |
| | user's information for version control. |
| System processes | System processes the edit for approval |
| edit 1305 | before publishing. |
| System has version | Each edit is subject to other contributors who |
| and revision control 1306 | can utilize version control and revise utilizing |
| | this system process. |
| Contributors check | Contributors review edits made by other |
| work 1307 | contributors to enforce system editing |
| | guidelines which include but are not limited |
| | to neutrality, balance and accuracy. System |
| | process shows specific prior contributing |
| | edits. |
| Contributors revise, | System processes version and revision |
| add or otherwise amend | control based on the current contributor's |
| 1308 | behavior. |

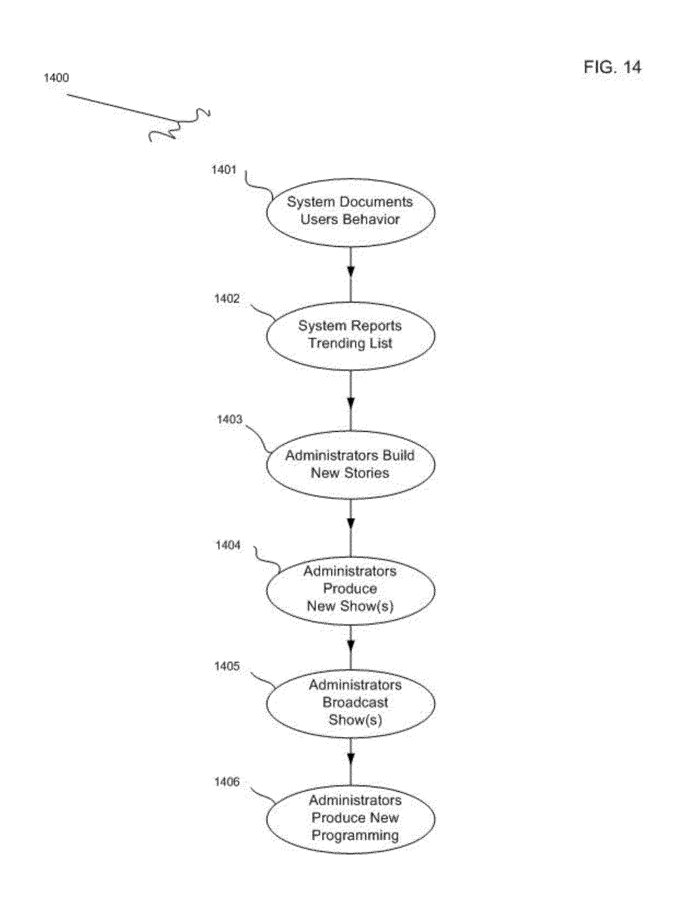

FIG. 14. Holding Deciding Officials Accountable 1400

| Title | Description |
|---|---|
| System documents | System recognizes and documents user's |
| user behavior 1401 | point of view in aggregate as they send |
| | letters and build groups and movements |
| | around bills and issues. |
| System reports | System reports data on trends in organizing |
| a trending list 1402 | and deciding official communications from |
| | users. |
| Administrators | Around trends reported by the system based |
| build news stories 1403 | on user behavior and communications, |
| | administrators build news stories and |
| | compare activity happening with deciding |
| | officials. |
| Administrators | Administrators produce a news show based |
| produce news show 1404 | around top user trends in communication |
| | and behavior. Deciding officials, journalists, |
| | experts and others are invited to discuss |
| | these trends in comparison to what deciding |
| | officials are focusing on. |
| Administrators | Administrators broadcast the show via web |
| broadcast the show 1405 | and TV. |
| OTHER: Administrators | This includes but is not limited to: blogs, |
| produce multi-media | podcasts, TV, cable, web series, other |
| news programming 1406 | content and assets. |

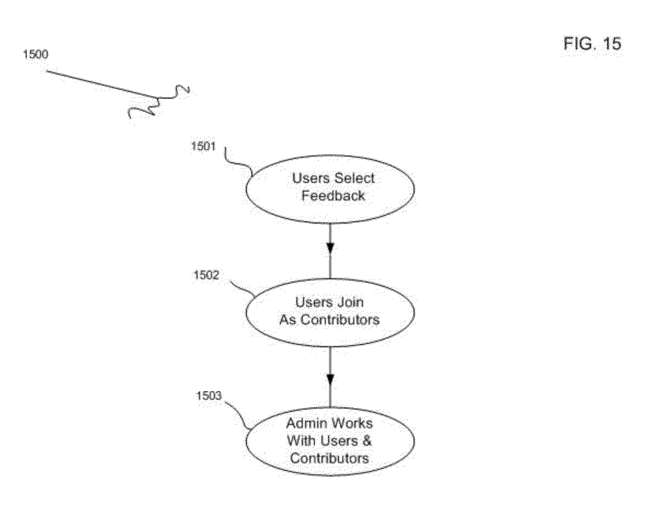

FIG. 15. Think Tank Feedback Method 1500

| Title | Description |
|---|---|
| Users select the | System generates a template page for users to |
| feedback button 1501 | comment on a variety of website issues |
| | including but not limited to: bill summary |
| | changes, site changes, site errors, content and |
| | asset suggestions. |
| Users join as | System generates a list of contributing pods |
| contributors 1502 | for the user to select from including but not |
| | limited to: public policy, coalition admin, |
| | movement admin, TV, social media, |
| | innovation, mobile. |
| Administrators | Administrators grow the relationship with |
| work with users and | their user and contributor. This relationship |
| contributors 1503 | can include but not limited to: wiki |
| | contributing, content, asset, collaboration, |
| | team building, |

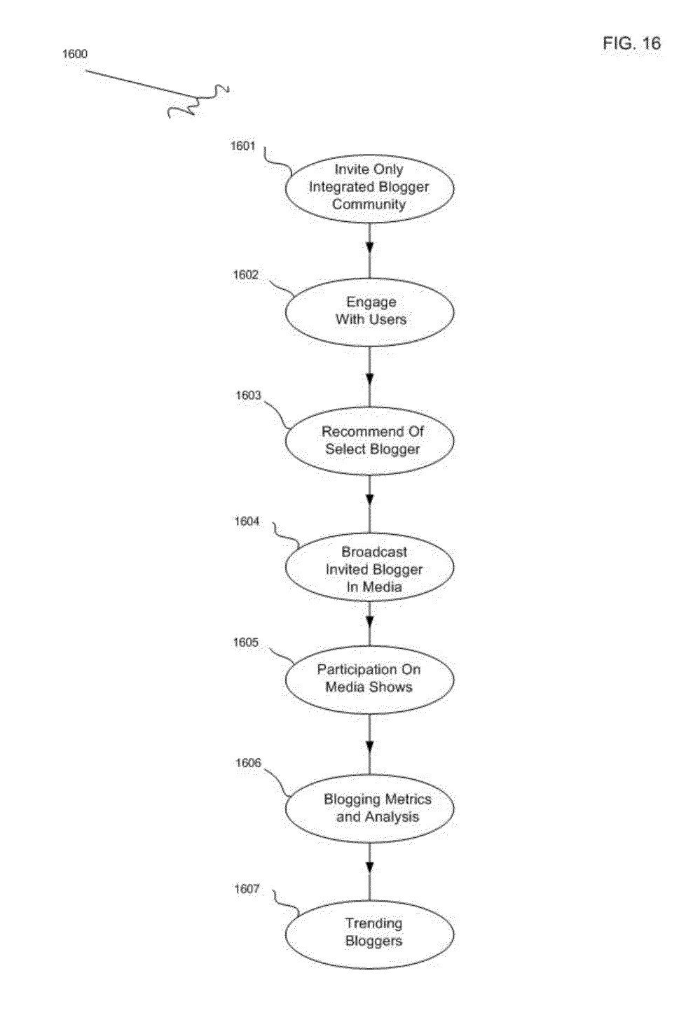

FIG. 16. Blogger Community Method 1600

| Title | Description |
|---|---|
| Invite-only integrated | Hand selected partisan-balanced group of |
| blogger community | bloggers are invited to engage with users on an |
| 1601 | integrated system. |
| Engage with users | Special bill related groups can be attached to |
| 1602 | each individual blogger and its community. |
| Recommend of select | Along with recommending groups who are of |
| blogger 1603 | similar political positions, invited bloggers are |
| | also recommended to users when they reveal |
| | similar interests. |
| Broadcast invited | Share feature of users and invited blogger of the |
| blogger in media 1604 | blogger community with social media including |
| | but not limited to: Facebook, Twitter, LinkedIn, |
| | Pinterest, YouTube, MySpace, broadcast TV, |
| | cable TV, originally produced shows. |
| Participation on | Invited bloggers are subject to guest panel roles |
| media shows 1605 | on media shows and interviews based on their |
| | position. Trending bloggers will be highlighted. |
| Blogging metrics | System provides metrics and analysis creating a |
| and analysis 1606 | success metric of the community measuring user |
| | engagement. |
| Trending bloggers | System provides published analysis of blogger |
| 1607 | communities related to user and coalition |
| | engagement and growth measures. |

What is claimed is:

1. A method of facilitating communications, comprising:
providing a list of interests to a user;
receiving a selection of one or more interests from the user;
automatically providing a list of one or more legislations to the user in response to the received selection of the one or more interests from the user.

2. The method of claim 1, further comprising:
receiving a user selection of a first legislation from the list of the one or more legislations.

3. The method of claim 2, further comprising:
determining one or more entities in response to the receiving the user selection; and
generating a communication to the one or more entities.

4. The method of claim 3, further comprising:
automatically determining one or more representatives of the user, wherein the one or more entities comprise the one or more representatives.

5. The method of claim 3, wherein the user is one of a plurality of users, and the method further comprises:
providing a list interests to the plurality of users;
from each of the plurality of users, receiving a selection of the one or more interests and storing the received selection as selection information;
wherein the one or more entities comprise others of the plurality of users determined by the stored selection information.

6. The method of claim 5, wherein the communication to the one or more entities is an invitation to join a first coalition, and wherein the method further comprises receiving an acceptance of the invitation to join the first coalition from a first user, and associating the user with the first coalition.

7. The method of claim 5, further comprising:
associating a first group of users with a first coalition,
wherein the one or more entities comprise the first group of users.

8. The method of claim 2, further comprising:
providing the user with one or more recommendations of coalitions to join in response to the user selection of the first legislation.

9. A method of facilitating communications, comprising:
for each of a plurality of users, storing information regarding areas of interest for the corresponding user;
providing an invitation to join a first coalition to a first user based on the stored information.

10. The method of claim 9, further comprising providing an invitation to join the first coalition to the first user in response to determining areas of interest of the first user are shared with areas of interests associated with the first coalition.

11. The method of claim 9, further comprising:
receiving first information and associating the first information with the first coalition;
using the first information to identify a plurality of users, including the first user; and
providing an invitation to the plurality of users to join the first coalition.

12. The method of claim 11, wherein the first information comprises keywords.

13. The method of claim 12, further comprises:
assigning an organizer of the first coalition,
wherein the keywords are provided by the organizer.

14. The method of claim 12, further comprising:
receiving a search query from the first user;
providing an invitation to the first user to join the coalition in response to the search query.

15. The method of claim 11, wherein the first information comprises a legislation.

16. The method of claim 15, wherein the legislation is a bill.

17. The method of claim 11, further comprising providing an invitation to join the first coalition to the first user in response to the first user selecting a legislation.

18. A method of facilitating communications, comprising:
for each of a plurality of users, receiving a user selection of one or more legislations and providing information relating to the user selection of one or more legislations;
aggregating user points of view of the plurality of users;
creating a video image in response to the step of aggregating user points of view.

19. The method of claim 18, further comprising:
determining trends based on user behavior of the plurality of users,
wherein the creating of the video image is responsive to the step of determining trends.

20. The method of claim 18, wherein aggregating user points of view comprises recognizing the sending of communications by at least some of the plurality of users.

21. The method of claim 19, wherein aggregating user points of view comprises recognizing building of groups of users.
